(19) United States
(12) Patent Application Publication
(10) Pub. No.: US 2005/0049932 A1
(43) Pub. Date: Mar. 3, 2005

(54) Process for managing subscription service purchases

(76) Inventors: James A. Howell JR., Georgetown, TX (US); Christopher W. Ramirez, Austin, TX (US)

Correspondence Address: Stephen A. Terrile;HAMILTON & TERRILE, LLP, PO Box 203518, Austin, TX, 78720, US

(21) Appl. No.: 10/654,387

(22) Filed: Sep. 3, 2003

(51) Int. Cl. G06F 17/60

(52) U.S. Cl. 705/26

(57) ABSTRACT

A system for enabling configuration of an information handling system which includes a configurator, a service activation module, and a subscription services management module. The configurator configures an information handling system with options selected according to user input. The service activation module enables a user to activate a service and the subscription services management module links information relating to an information handling system order with information relating to a service order.

### BACKGROUND OF THE INVENTION

1. Field of the Invention

The present invention relates to build to order systems, and more particularly, managing subscription service purchases in build to order systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A first generation web based on-line store provided a customer with an ability to select a base information handling system, customize the system and price it. Such an on-line store focused initially upon the bare necessities. That is, build a system and get a price. A configurator allowed the customer to customize and procure the system on-line. The configurator allowed the customer to select a given system model and to customize the system according to the user selected options. Such a configurator was most well received by knowledgeable customers, that is, those who were very self-sufficient without the assistance of a sales representative.

Known on-line stores included a web objects based application providing the capability to custom configure and order a particular system. The initial on-line store application offered customers the ability to select and price key system options, the ability to include multiple systems on a single order, and the ability to provide information necessary for the placement of a standard system order.

The capability to self-select system options and then price the options was provided via an on-line configurator. This configurator enabled customer selection of key, system-defining components from a display of available system options for a chosen system. The display of available options included the presentation of a “delta” price, wherein a change in system price was affected by selection of an option. The configurator provided the ability to update overall system priced based upon selections made. The capability to include multiple items in a single order was afforded by the presence of a “shopping cart,” wherein the shopping cart represents an equivalent to the traditional shopping cart. The shopping cart enabled customers to group disparate systems together as an order, as well as specify a quantity for each individual system to be included on the order. Furthermore, the capability to provide customer-specific information required for the placement of a standard order was provided via an on-line “checkout,” the checkout including essentially a form for facilitating the capture of requested and required information. The checkout form included simple logic rules to assure entry of the required fields.

After a system is ordered, the customer may be provided the opportunity to order a particular service such as Internet service. When the customer indicates a desire to order such a service, then the on-line store transfers (i.e., links) the customer to the web site for the particular service in which the customer is interested. Often the web site for the service provides its own look and feel, different from the look and feel of the on-line store. Also, the customer experience changes with the link to the web site of the service provided. Also, after the customer has transferred to the new web site, the original on-line store no longer has control or can access the information provided by the customer.

With the integration of processes to support the integration of registration capabilities into an on-line checkout process, multiple issues arise when dealing with different providers and in managing the differences in the various registration processes of the providers. For example, because narrowband registration is integrated into checkout and customers are actually creating their account before purchasing their system, then it is desirable to provide the manufacturer with a means for canceling the account if the customer does not actually complete a system purchase. Also for example, with a broadband qualification and registration, there are multiple providers and different touch points for each provider. The same issue as with narrowband is present if the account registration is completed before the check-out process is complete and a system is not actually ordered.

Known systems may manage individual or singular subscription product registrations within commerce system of the provider. However, such systems do not specifically provide a unified subscription management process.

### SUMMARY OF THE INVENTION

In accordance with the present invention, a unified subscription services management module is provided. The module can be used within an on-line store or within an integrated telephone sales tool. The unified process defines standard methods for collecting relevant data necessary to create subscriptions, managing the subscription based upon manufacturer specific order information (such as “was the order completed”) and links the subscription registration status to a customer order so that the status for both the order and the provisioning can be checked in a single location.

In one embodiment, the invention relates to a system for enabling configuration of an information handling system which includes a configurator, a service activation module, and a subscription services management module. The configurator configures an information handling system with options selected according to user input. The service activation module enables a user to activate a service and the subscription services management module links information relating to an information handling system order with information relating to a service order.

In another embodiment, the invention relates to a method of enabling configuration of an information handling system which includes configuring an information handling system with options selected according to user input, enabling a user to activate a service, and linking information relating to an information handling system order with information relating to a service order.

In another embodiment, the invention relates to an on-line store for enabling configuration of an information handling system which includes means for configuring a system with options selected according to user input, means for enabling a user to activate a service, and means for linking information relating to a system order with information relating to a service order.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a system block diagram of an information handling system.

FIG. 4 shows a functional block diagram of the operation of the on-line store having a subscription services management module.

### DETAILED DESCRIPTION

An on-line store is one component of an Internet website to which a customer may go to configure a particular information handling system, for example, according to desired options of the customer. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

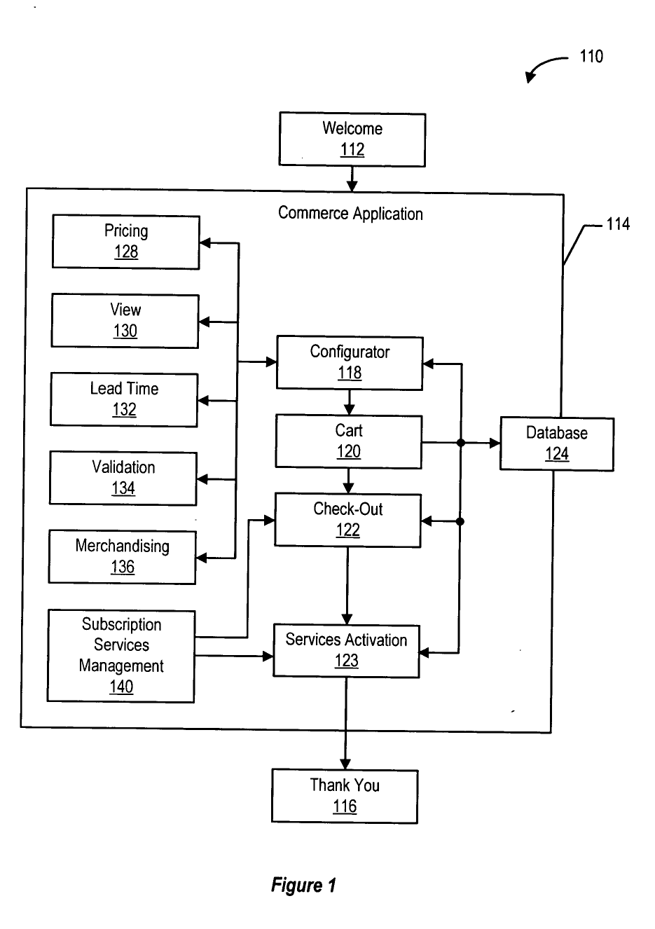

Referring now to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and services activation module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and services activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the services activation module 123 presents a services activation page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a services activation page in which the customer is provided an opportunity to activate various services such as internet service or content services such as music services. After completion of the services activation module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and services activation module 123 are each part of the commerce application 114 and interact with the database 124. For example, with the shopping cart 120, additional merchandising information associated with a particular system which has been configured and placed in the shopping cart by an on-line store customer can be provided.

Also for example, various services may be provided for order by the customer by the services activation module 123 based upon the type of system ordered as well as components that are included within the system ordered. Additionally, by providing the services activation module within the commerce application 114, the customer continues to experience a similar customer experience and the system provider is able to use the information from the database 124 and to maintain control over the customer contact. By maintaining control over the customer contact, the system provider is able to determine what services are activated and to maintain accurate and up to date records of the service activation.

The commerce application 114 includes a unified subscription services management module 140. The unified subscription service management module 140 defines standard methods for collecting relevant data necessary to create subscriptions, manages the subscription based upon manufacturer specific order information (such as “was the order completed”) and links the subscription registration status to a customer order so that the status for both the order and the provisioning can be checked in a single location. More specifically, the subscription service management module 140 communicates and interprets between a manufacturer order management system and a subscription service provider order management system. The communicating includes interpreting provider information back to manufacturer part numbers and linking manufacturer order information such as manufacturer order numbers to subscription registration information such as subscription registration confirmations. The subscription service management module 140 is also responsible for canceling subscription service orders corresponding to manufacturer system orders. For example, if a manufacturer system order is canceled for any reason, the subscription services management module 140 may automatically send a cancellation request to the subscription service provider.

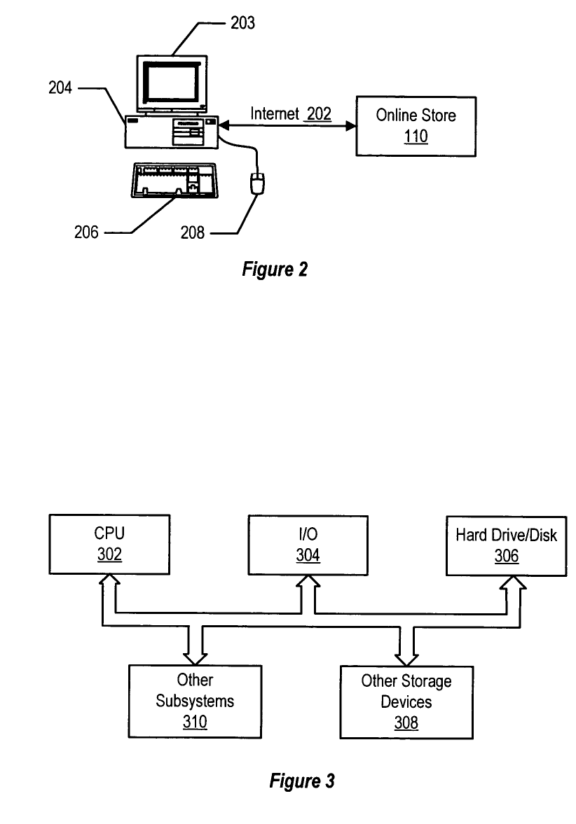

Referring to FIG. 2, a customer can access the on-line store 110 using any suitable computer equipment 200, via the Internet 202. The computer equipment 140 may include a display 203, computer 204, keyboard 206, and pointing device 208. Display 203 is used for displaying the various pages of the on-line store while a customer is using the on-line store.

Referring briefly to FIG. 3, a system block diagram of an information handling system 150 is shown having features thereof configured in accordance with the on-line store 110 as discussed herein. The information handling system 150 includes a processor 302, input/output (I/O) devices 304, such as a display, a keyboard, a mouse, and associated controllers, non-volatile memory such as a hard disk drive 306, and other storage devices 308, such as a floppy disk and drive and other memory devices, and various other subsystems 310, all interconnected via one or more buses, shown collectively as bus 312. Service information, such as registration information, is stored on non-volatile memory of the information handling system such as the hard disk drive 306.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

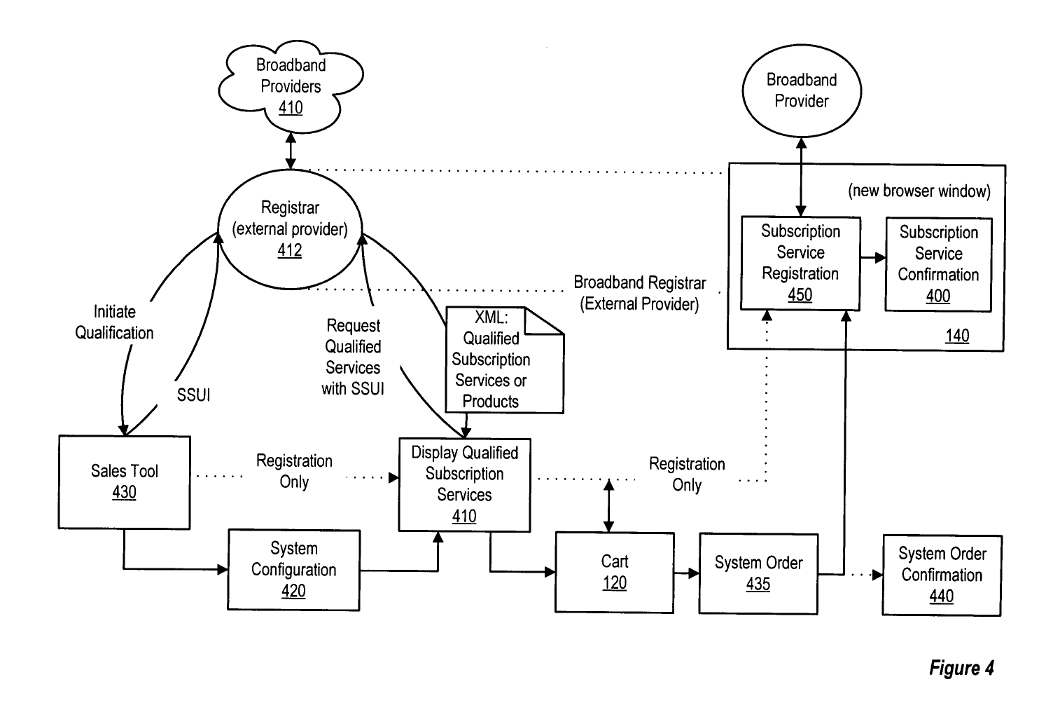

Referring to FIG. 4, a functional block diagram of the operation of the on-line store having a subscription services management module 140 is shown. For examplative purposes, the subscription described is a broadband subscription. However, it will be appreciated that any subscription service or product may be managed via the subscription services management module 140.

More specifically, broadband providers 410 interact with a registrar module 412 which interacts with the subscription service management module 140. The registrar module 412 provides an official recorder function for respective external providers. The registrar module 412 also interacts with the configurator 118 while the configurator 118 is performing a system configuration 420.

More specifically, the registrar 412 enables a customer to be loaded in a sales tool module via a session specific unique identifier (SSUI). The sales tool module 430 initiates a qualification determination of the service and provides information relating to the qualification determination back to the registrar module 412. The sales tool module 430 also provides registration information to the configurator 118, which registration information is then included within the system configuration 420. The qualification request for the service may be processed in the background (i.e., simultaneously with) the system configuration 420. The sales tool module 430 may also provide information directly to a subscription services module 440 if the customer indicates a registration only option while in the sales tool module 430. The registration only option allows a customer to perform a subscription product registration while not configuring or purchasing an information handling system.

The registrar 412 also provides information regarding qualified subscription services to the subscription services module 440. This information may be in the form of, for example, an XML document. The subscription services module 440 presents information to a user of qualified subscription services. The subscription services module 440 presents a request to the registrar 412 to obtain information regarding qualified subscription services for a particular user.

When one or more subscription services are chosen, then the system 114 proceeds to the cart 120. The subscription services management module 140 maps subscription services to a manufacturer part number. Next the system 114 proceeds to generating a system order via module 435. The system order module 435 then generates a system order confirmation 440. The subscription product confirmation information is mapped back to a manufacture order number. This mapping allows for future status checks based upon a manufacturer order number or on a subscription services confirmation number.

The system order module 435 also transfers control to a subscription service registration module 450. The subscription service registration information may be presented via a new browser window. The subscription service registration module 450 interacts with a selected subscription provider, such as a broadband provider, to process the subscription services information. When the subscription service registration information is entered and processed, then the subscription services management module 140 generates a subscription service confirmation via subscription service confirmation module 460.

If the system order is cancelled, the subscription service order should also be cancelled. The subscription services management module 140 provides cancellation information to a subscription provider based upon information that is stored within the manufacturer's order management system, such as information stored within database 124.

Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while an example is set forth having a broadband service. Any type of subscription product or service may be managed via the subscription services management module. A subscription service is understood to include and be equivalent to a subscription product.

Also for example, the services activation module 123 which interacts with the database 124 may be used by a telephone sales person when a system is being ordered via the telephone. In this situation, the information that is derived by the telephone sale person during a customer interview is then used to provide the customer with the option of services activation. Accordingly, the customer continues the experience a similar customer experience and the system provider is able to use the information from its database and to maintain control over the customer contact. By maintaining control over the customer contact the system provider is able to determine what services are activated and to maintain accurate and up to date records of the service activation.

Also for example, the service activation may occur before the actual check out. Also for example, the services activation may occur after the thank you module; in this example, the thank you module and the services activation module may both be located within the commerce application.

Also for example, while specific services are identified as being activated by the services activation module, other services may also be activated by the services activation module. Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A system for enabling configuration of an information handling system comprising:
a configurator, the configurator configuring an information handling system with options selected according to user input;
a service activation module, the service activation module enabling a user to activate a service; and,
a subscription services management module, the subscription services management module linking information relating to an information handling system order with information relating to a service order.

2. The system of claim 1 further comprising:
a registration only option, the registration only option linking information relating to the service order with manufacturer identification information.

3. The system of claim 1 wherein:
the subscription services management module includes functionality for canceling the service order corresponding to a particular information handling system order.

4. The system of claim 3 wherein:
the subscription services management module automatically generates a cancellation request to a service provider if a corresponding information handling system order is canceled.

5. The system of claim 1 wherein:
the subscription services management module generates a services qualification request for a customer, the services qualification request determining whether a customer is qualified to subscribe to a particular service.

6. The system of claim 5 wherein:
the services qualification request is processed substantially simultaneously with the configuring the information handling system.

7. The system of claim 1 wherein:
the configurator and the service activation module provide a customer with a consistent customer experience.

8. A method of enabling configuration of an information handling system comprising:
configuring an information handling system with options selected according to user input;
enabling a user to activate a service; and
linking information relating to an information handling system order with information relating to a service order.

9. The method of claim 8 further comprising:
providing a registration only option, the registration only option linking information relating to the service order with manufacturer identification information.

10. The method of claim 8 further comprising:
canceling the service order corresponding to the information handling system order if a corresponding information handling system order is not completed.

11. The method of claim 8 further comprising:
automatically generating a cancellation request to a service provider if the corresponding information handling system order is canceled.

12. The method of claim 8 further comprising:
generating a services qualification request for a customer, the services qualification request determining whether a customer is qualified to subscribe to a particular service.

13. The method of claim 12 wherein:
the services qualification request is processed substantially simultaneously with the configuring the information handling system.

14. The method of claim 8 further comprising:
providing the customer with a consistent customer experience during the configuring and the enabling.

15. An on-line store for enabling configuration of an information handling system comprising:
means for configuring a system with options selected according to user input;
means for enabling a user to activate a service; and
means for linking information relating to a system order with information relating to a service order.

16. The on-line store of claim 15 further comprising:
means for providing a registration only option, the registration only option linking information relating to the service order with manufacturer identification information.

17. The on-line store of claim 15 further comprising:
means for canceling the service order corresponding to the information handling system order if a corresponding information handling system order is not completed.

18. The on-line store of claim 17 further comprising:
means for automatically generating a cancellation request to a service provider if the corresponding information handling system order is canceled.

19. The on-line store of claim 15 further comprising:
means for generating a services qualification request for a customer, the services qualification request determining whether a customer is qualified to subscribe to a particular service.

20. The on-line store of claim 19 wherein:
the services qualification request is processed substantially simultaneously with the configuring the information handling system.

21. The on-line store of claim 15 further comprising:
means for providing the customer with a consistent customer experience during the configuring and the enabling.
